(19) United States
(12) Patent Application Publication
(10) Pub. No.: US 2025/0158419 A1
(43) Pub. Date: May 15, 2025

(54) Case to Earbud Communication Without Interrupting Charging

(71) Applicant: QUALCOMM Incorporated, San Diego, CA (US)

(72) Inventors: Shamim AHMED, Mesa, AZ (US); Christian CAMPORESE, Cambridge (GB)

(21) Appl. No.: 18/508,051

(22) Filed: Nov. 13, 2023

(51) Int. Cl. H02J 7/00

(52) U.S. Cl. CPC H02J 7/00032; H02J 7/0042

(57) ABSTRACT

An electronic device includes an input terminal and a data receiver coupled to the input terminal. The electronic device also includes a battery coupled to the input terminal. The data receiver includes a high-pass filter coupled between the input terminal and an input to a comparator that produces a digital received signal while a modulated charging voltage drives the input terminal.

### TECHNICAL FIELD

This application relates to electronic devices, and more particularly, to the communication of data between an earbud case and an earbud without interrupting charging of the earbud's battery.

### BACKGROUND

The battery of an earbud (an in-ear headphone) is typically charged while the earbud is received by a charging case. For example, the earbud will generally include an input terminal that makes an electrical contact with a corresponding output terminal in the case. Because an earbud typically has a limited number of terminals (for example, just the input terminal and a ground terminal), the input terminal functions to not only receive a charging voltage during a charging mode but also to receive a data signal during a data mode. But the charging of the battery within an earbud typically requires an elevated voltage level for the charging voltage such as greater than 3.3 volts. Such an elevated voltage may not be suitable for a data receiver in the earbud. The charging and data modes for an earbud are thus typically non-concurrent. A charging mode may then be interrupted by a data mode, which lengthens the charging time.

### SUMMARY

In accordance with an aspect of the disclosure, an electronic device is provided that includes: an input terminal for receiving a charging voltage; a first voltage divider configured to divide a power supply voltage into a divided voltage at a first node; a second voltage divider configured to divide the power supply voltage into the divided voltage at a second node; a high-pass filter including a high-pass filter capacitor coupled between the input terminal and the first node; and a comparator configured to compare a voltage of the first node to a voltage of the second node to form a digital received signal.

In accordance with another aspect of the disclosure, a method of receiving data from a charging voltage to an electronic device is provided that includes: high-pass filtering a modulated charging voltage to form a high-pass filtered voltage; combining the high-pass filtered voltage with a common-mode voltage to form a combined voltage; and comparing the combined voltage to the common-mode voltage to form a digital received signal while using the modulated charging voltage to charge a battery in the electronic device.

In accordance with yet another aspect of the disclosure, an earbud is provided that includes: an input terminal; a charging rail for a charging voltage; an input switch coupled between the input terminal and the charging rail; and a data receiver coupled to the input terminal, wherein the data receiver includes a comparator and a high-pass filter coupled between the input terminal and a first input of the comparator.

These and other advantageous features may be better appreciated through the following detailed description.

### BRIEF DESCRIPTION OF THE DRAWINGS

FIG. 1 is a diagram of a case including an earbud in accordance with an aspect of the disclosure.

FIG. 2 is a circuit diagram of a data receiver circuit for an earbud in accordance with an aspect of the disclosure.

FIG. 3 illustrates an earbud charging voltage waveform that is modulated with a data signal in accordance with an aspect of the disclosure.

FIG. 4 illustrates an internal node voltage waveform of a data receiver circuit in accordance with an aspect of the disclosure.

FIG. 5 is a circuit diagram of a data receiver circuit for an earbud in accordance with an aspect of the disclosure.

FIG. 6 is a flowchart of a method of operation for an earbud in accordance with an aspect of the disclosure.

Implementations of the present disclosure and their advantages are best understood by referring to the detailed description that follows. It should be appreciated that like reference numerals are used to identify like elements illustrated in one or more of the figure.

### DETAILED DESCRIPTION

An inability to charge an earbud during the transfer of data to the earbud may lengthen the battery charging time and thus reduce user satisfaction. To address this issue, an advantageous earbud is disclosed in which data communication from the case to the earbud may occur while the earbud is being charged. Before the advantageous earbud disclosed herein is discussed in further detail, some challenges to its design will first be discussed. Note that an earbud is not typically charged through an interface such as universal serial bus (USB) interface that supports simultaneous data communication and battery charging. For example, the earbud is generally too small for such an interface. Moreover, the use of a USB interface would complicate the simplicity and ease by which a user may merely place the earbuds in the case and close the case cover to begin charging. With regard to its electrical coupling to the case, an earbud typically has a limited number of terminals (for example, just two terminals). With just two terminals, one terminal is typically a ground terminal and another terminal is an input terminal. The input terminal thus functions both to receive a charging voltage and also to receive a data signal. The data encoded within the data signal is also denoted herein as a digital message. During a charging mode, the input terminal receives a charging voltage (VCHG) for charging a battery in the earbud. Because this charging voltage is relatively elevated, it is unsuitable for high-speed data communication as such a relatively-high voltage could damage a high-speed data receiver in the earbud. During a high-speed data mode (for example, transferring data according to a 1.5 MHz clocking rate), the input terminal may thus receive a high-speed data signal that has a reduced voltage as compared to the charging voltage.

During a charging mode, the charging voltage at the input terminal couples through an input switch in the earbud to an internal charging rail or node. For example, the earbud may have an integrated circuit having a charging pin or terminal coupled to the internal charging rail for receiving the charging voltage. But the reduced voltage of the high-speed data signal during the high-speed data mode is generally not suitable for charging the earbud's battery. Thus, during the high-speed data mode, the earbud may open the input switch to isolate the internal charging rail from the input terminal. A typical earbud may then operate in a high-speed data mode in which the input switch is opened. But such a high-speed data mode then lengthens the charging time since no charging can take place while the input switch isolates the internal charging rail from the input terminal.

To reduce the charging time and thus increase user satisfaction while still transferring data to the earbud, an improved earbud is disclosed that allows the input switch to be closed during a data mode so that the improved earbud may also be charged while it receives data. The charging voltage is thus modulated with the data to be transmitted during such a data mode. Although what is low-speed data transmission versus what is high-speed data transmission is a relative concept, the resulting data mode is denoted herein as a low-speed data mode without loss of generality. Since the input switch is closed during the low-speed data mode, the charging voltage (VCHG) from a power converter in the earbud case such as a buck/boost switching power converter will flow through an output terminal of the case and then through the input terminal and the input switch to the charging rail of the earbud. Note that the charging voltage will typically vary over a fairly wide range. For example, the charging voltage may vary from 3.3V to 6.5V in some implementations. This variation of the charging voltage depends upon various factors including the charging state of the earbud's battery. Should the earbud battery be discharged, the charging voltage begins the battery charging at the lower end of its charging range and then increases as the earbud battery becomes more and more charged.

Since the charging voltage is thus tied to the earbud battery charging state, the modulation of the charging voltage should not significantly affect its average value. The following discussion will thus be directed to a pulsed modulation of the charging voltage such that the charging voltage is either increased from its direct current (DC) value by a relatively-small voltage increment (e.g., 100 mV) or decreased from its DC value by a relatively-small voltage decrement (e.g., −100 mV). In this fashion, there is a 200 mV spread between the increased and decreased states of the modulation so that the binary transitions in the modulation may be readily detected. However, it will be appreciated that other increment/decrement values in the modulation of the charging voltage may be used in alternative implementations.

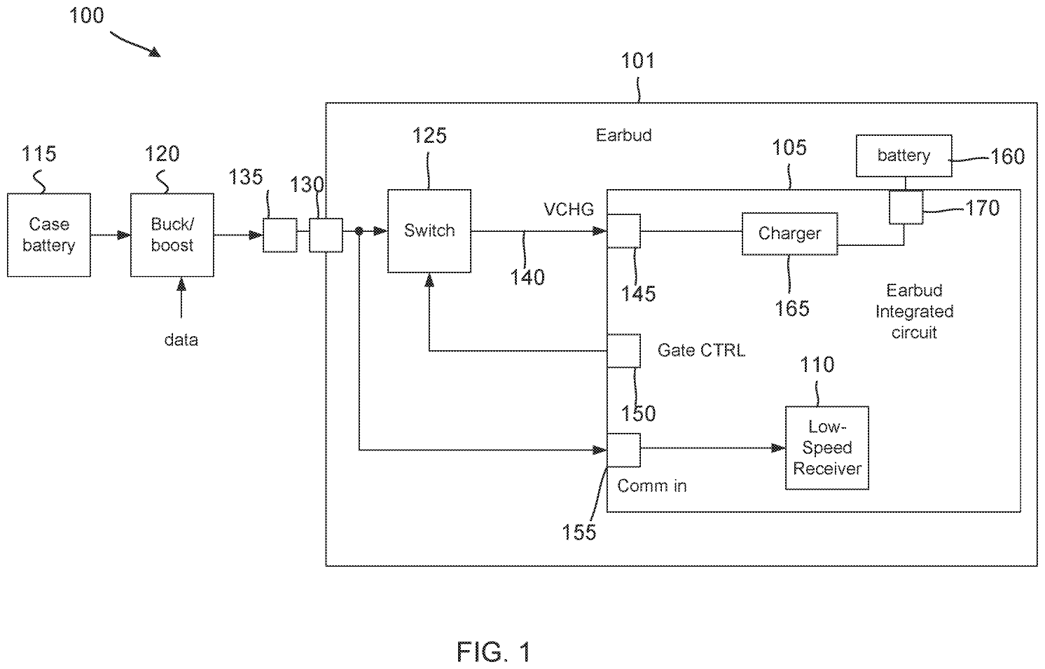

The following discussion will be directed to various example earbuds that may each receive data over an input terminal while a battery in the earbud is charged through the input terminal. However, it will be appreciated that any suitable electric device (e.g., a smartwatch) that receives a charging voltage over an input terminal and also receives data over the input terminal may advantageously include the data receiver discussed herein. A case 100 enclosing or otherwise receiving an example earbud 101 is shown in FIG. 1. The case 100 includes a switching power converter such as a buck/boost switching power converter 120 that generates an unmodulated version of the charging voltage VCHG from a battery voltage of a casing battery 115 during a charging mode. During the low-speed data mode, the buck/boost converter 120 modulates the unmodulated charging voltage responsive to an input data stream to produce a modulated charging voltage at an output terminal 135 of the case. However, it will be appreciated that a separate modulator may be used to modulate the charging voltage in alternative implementations. As discussed previously, the earbud 101 does not support an interface such as a USB interface that includes parallel data and power paths to the earbud 101. Such parallel and separate paths would make the simultaneous transmission of power and data a routine exercise. But earbud 101 does not have the luxury of such an interface as discussed previously. Instead, earbud 101 couples to the output terminal 135 through an input terminal 130 for both the reception of data and also for receiving the charging voltage.

Earbud 101 may charge an earbud battery 160 not only during a charging mode (no transfer of data) but also during a low-speed data mode. The input terminal 130 couples through an input switch 125 to a charging rail or node 140. Earbud 101 includes at least one integrated circuit 105 having a charging terminal 145 coupled to the charging rail 140 for receiving the charging voltage (VCHG). During a high-speed data mode, the integrated circuit 105 drives a gate control terminal 150 with a gate control (CTRL) signal to open the input switch 125. In this fashion, the charging terminal is isolated from the charging voltage during the high-speed mode. The input terminal 130 also couples to a communication (Comm in) terminal 155 of the integrated circuit 105. A transmitter (not illustrated) in the case 100 can then drive a high-speed data signal through the output terminal 135, the input terminal 130, and the communication terminal to drive a high-speed receiver (not illustrated) within the integrated circuit 105.

As discussed previously, the high-speed data signal has too low of a voltage for charging the earbud battery. Thus, the switch 125 is opened during the high-speed data mode to prevent a faulty charging state for the earbud battery. In some implementations, the high-speed data signal may alternate between ground and a maximum voltage of 1.8 V and as such cannot be used for battery charging while high-speed receiving of data takes place. Switch 125 is open during the high-speed data mode to isolate any capacitance of the charging terminal 140 from loading the incoming data signal. To prevent the resulting increase in the charging time, data may instead be communicated to the earbud 101 during the low-speed data mode. Unlike the high-speed data mode, switch 125 is closed during the low-speed data mode. Thus, the integrated circuit 105 does not assert the gate control signal during the low-speed data mode so that charging may continue to the earbud battery.

During the low-speed data mode, the modulated charging voltage couples through the switch 125 to the charging terminal 145. Integrated circuit 105 may include a charging circuit 165 (for example, a switching power converter) that couples between the charging terminal 145 and a battery terminal 170 to control the charging of the battery 160 during the low-speed data mode. At the same time, the modulated charging voltage couples from the input terminal 130 through the communication terminal 155 to a low-speed receiver 110. The modulation of the charging voltage may be responsive to a clock signal (not illustrated) that has a varying rate (e.g., from 1 KHz to 5 KHz). Within each period of the varying clock signal, a binary one or a binary zero may be modulated according to a pulse width that defines a duty cycle. Just like the clock rate, the duty cycle may vary and is thus not guaranteed to be 50%. The varying clock rate and the duty cycle make the design of the low-speed data receiver 110 challenging. For example, a low-speed data receiver could a low-pass-filter-based receiver. In such a receiver, the modulated charging voltage may be divided to form a divided voltage. A comparator may then compare a low-pass-filtered version of the divided voltage to the divided voltage to form a digital received signal. But note that the average value of the modulated charging voltage will depend upon its duty cycle. Should the pulsed-high state of the modulated charging voltage exceed its pulsed-low state, the low-pass filter may then incorrectly detect the proper average value. Moreover, should the clock frequency for the modulation of charging voltage be too low, the average value may oscillate. In addition, the time constant for the low-pass filter may require a relatively large resistance and capacitance to implement, which raises manufacturing costs. Moreover, the required time constant for the low-pass filter may result in a slow turn-on time for the low-speed receiver 110.

In another option to design the low-speed receiver 110, the divided voltage may processed through a peak detector and a subtractor circuit to generate a reference voltage. A comparator may then compare the divided voltage to the reference voltage to generate a digital received signal. But such an approach may be relatively complex and consume substantial power.

In yet another approach to design the low-speed receiver 110, a fully-differential operational amplifier may be used. But given the relatively large dynamic range of the DC value of the modulated charging voltage (e.g., from 3.3V to 6.5V), a fully-differential operational amplifier implementation may require dynamic tracking of the DC value, which maybe complex to implement.

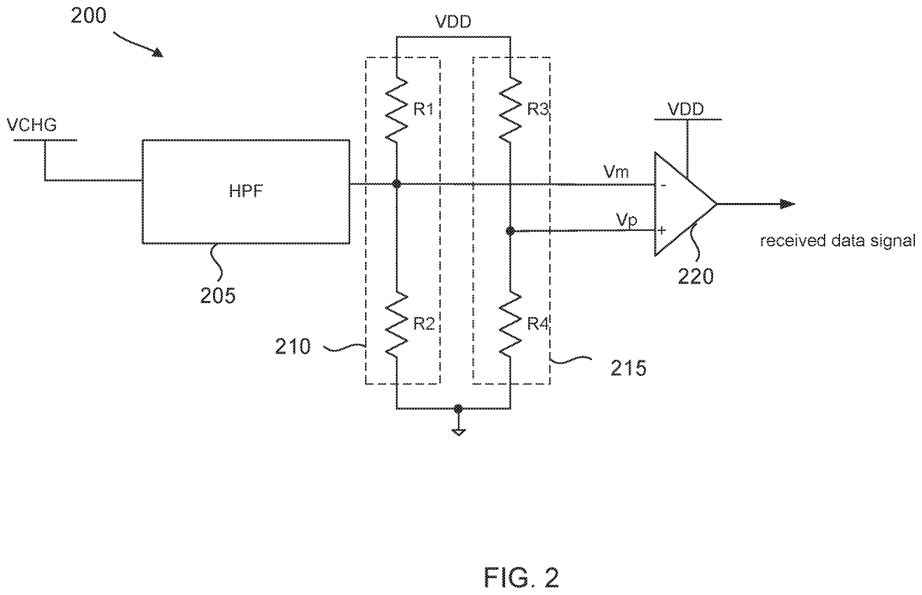

In light of all these challenges, an advantageous high-pass-filter-based low-speed data receiver 200 is disclosed as shown in FIG. 2. A high-pass filter (HPF) 205 filters the modulated charging voltage (VCHG) to drive an internal node Vm of a first voltage divider 210 formed by a resistor R1 and a resistor R2. The resistor R1 couples between a power supply node for an earbud power supply voltage VDD and the internal node Vm. The earbud power supply voltage VDD may be a well-regulated voltage generated inside the earbud integrated circuit 105 such as through a switching converter or a linear regulator. The resistor R2 couples between the internal node Vm and ground. The internal node Vm will thus be charged to a combination of a divided version of the power supply voltage VDD and a high-pass filtered version of the modulated charging voltage VCHG. More generally, the voltage of the internal node Vm equals a sum of the high-pass-filtered voltage from the high-pass filter 205 and a common-mode voltage produced by the division of the earbud power supply voltage VDD.

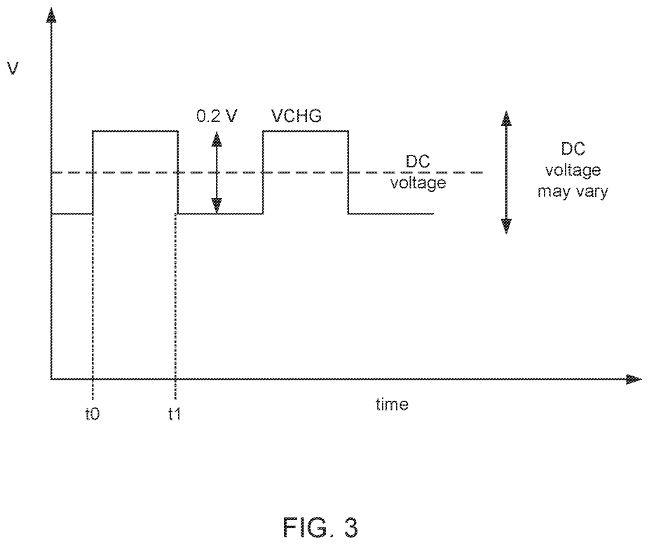

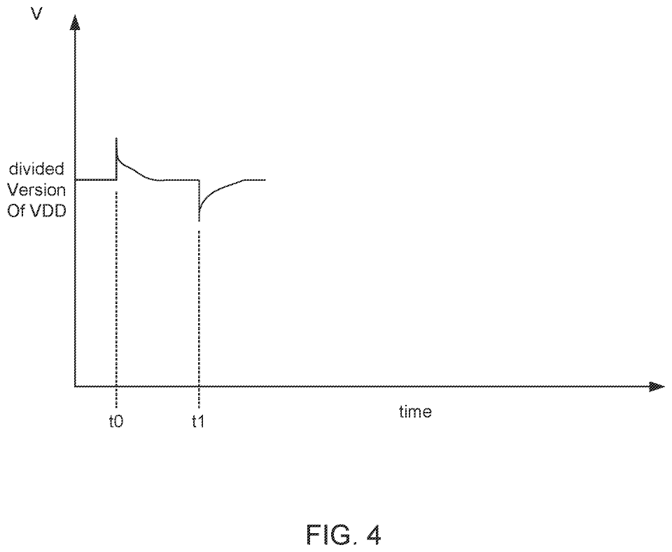

To provide a better appreciation of the advantages of the high-pass filtering of the modulated charging voltage, the waveforms of FIG. 3 and FIG. 4 will now be discussed. FIG. 3 illustrates an example waveform for the modulated charging voltage VCHG. At a time t0, the modulation switches from the pulsed-low state to the pulsed-high state. As discussed previously, the modulation should not cause too high or too low of a swing from a desired DC (average) voltage for VCHG. For an implementation in which the pulsed-high state is 100 mV greater than the DC voltage and the pulsed-low state of the modulated charging voltage is 100 mV lower than the DC voltage, the modulated charging voltage thus increases by 200 mV at time t0. At a time t1, the modulated charging voltage then decreases by 200 mV to transition from the pulsed-high state back to the pulsed-low state. Note that the increase and/or decrease from the DC voltage may be greater or smaller than 100 mV in alternative implementations. The DC voltage may vary over a relatively wide range such as 3.3V to 6.5V as noted earlier.

As shown in FIG. 4, the Vm node voltage waveform has a DC value that equals the divided version of the power supply voltage VDD. This DC value may also be denoted as a common-mode voltage. At time t0, the rising edge of the modulated charging voltage passing through the high-pass filter 205 causes the Vm node voltage to pulse high. The Vm node voltage then declines to its DC value before pulsing low at time t1 due to the falling edge of the modulated charging voltage passing through the high-pass filter 205. The resulting Vm node voltage may be advantageously sensed to recover the transmitted bits. In that regard, a second voltage divider 215 as shown in FIG. 2 may also generate the divided version of the power supply voltage VDD at an internal node Vp. The second voltage divider 215 is formed by a resistor R3 and a resistor R4. The resistor R3 couples between the power supply node for the earbud power supply voltage VDD and the internal node Vp. The resistor R4 couples between the internal node Vp and ground. The voltage division in voltage dividers 210 and 215 is ideally the same/balanced so that the voltage of the internal node Vp equals the common-mode voltage of the internal node Vm.

A comparator 220 powered by the earbud power supply voltage VDD has an inverting input that couples to the internal node Vm and has a non-inverting input that couples to the internal node Vp. More generally, the comparator has a first input coupled to the internal node Vm and has a second input coupled to the internal node Vp. The internal node Vm may also be denoted herein as a first node whereas the internal node Vp is also denoted as a second node. Given this coupling to the inputs of the comparator 220, the comparator 220 produces a digital received signal that pulses high to VDD at the falling edges of the modulated charging voltage and discharges to ground at the rising edges of the modulated charging voltage. Note that this convention may be reversed if the internal node Vm instead couples to the non-inverting input and the internal node Vp couples to the inverting input. In such an implementation, the digital received signal from the comparator 220 would pulse high to VDD at the rising edges of the modulated charging voltage and discharge to ground at the falling edges of the modulated charging voltage.

The resulting recovery by the earbud 101 of the transmitted bits in the digital received signal from the comparator 220 is quite advantageous as it is substantially independent of the clocking frequency and duty cycle of the charging voltage. Moreover, the high-pass filter 205 does not draw a DC current. In addition, no reference voltage generation is necessary and the low-speed data receiver needs only the earbud power supply voltage VDD for its power. For the high-pass filter 205 to sufficiently pulse the Vm node voltage so that the comparator 220 can be triggered may depend upon a minimum slew rate (e.g., 10 kV/sec in some implementations) for the modulated charging voltage. But since the data transmission is relatively low-speed (e.g., from 1 KHz to 5 KHz), such a minimum slew rate is readily satisfied. Finally, since the low-speed data receiver 200 is a high-pass-filter-based receiver, it is insensitive to the varying DC value of the modulated charging voltage.

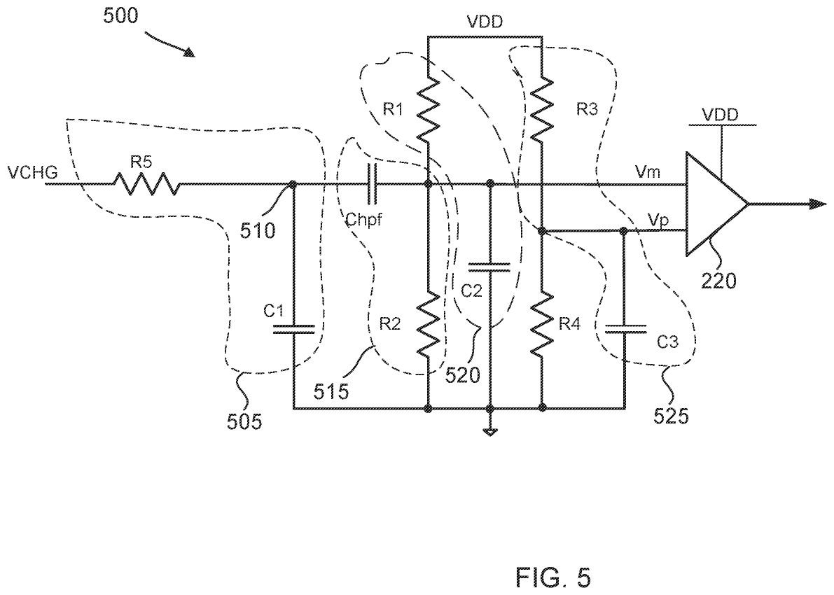

An example low-speed receiver 500 is shown in more detail in FIG. 5.

The first and second voltage dividers are formed by resistors R1, R2, R3, and R4 and arranged with respect to comparator 220 as discussed with regard to FIG. 2. A low-pass filter 505 formed by a resistor R5 and a capacitor C1 low-pass filters any high-speed ripple on the modulated charging voltage VCHG and produces a filtered voltage at a node 510. The resistor R5 couples between the input terminal 130 (FIG. 1) and the node 510. The capacitor C1 couples between the node 510 and ground. The node 510 also functions as an input node to a high-pass filter 515 formed by a high-pass filter capacitor (Chpf) and resistor R2. The high-pass filter capacitor couples between node 510 and the Vm node. To filter out any high frequency variation from the earbud power supply voltage VDD, a capacitor C2 couples between the Vm node and ground to form a low-pass filter in combination with resistor R1. Similarly, a capacitor C3 couples between the Vp node and ground to form a low-pass filter in combination with resistor R3. In this fashion, the common-mode voltage of the Vm and Vp nodes is substantially free from any high-frequency variation in the earbud power supply voltage VDD. Capacitor C2 is also denoted as a first capacitor herein whereas capacitor C3 is also denoted as a second capacitor.

To prevent any remaining noise in the Vm and Vp node voltages from affecting the comparison in comparator 220, comparator 220 may have a certain amount of offset (e.g., 15 mV minimum offset in some implementations). Similarly, a minimum peak-to-peak voltage variation (e.g., 100 mV in some implementations) of the Vm node voltage ensures that the comparator 220 will detect the rising and falling edges in the Vm node voltage. Given this offset, the comparator 220 will not assert the digital received signal until the Vp node voltage is higher than the Vm node voltage by an offset value or amount (e.g., 15 mV). Similarly, the comparator 220 will not discharge the digital received signal until the Vm node voltage is higher than the Vp node voltage by the offset value. In addition to an offset, the comparator 220 may also have some hysteresis to prevent jitter at the comparator output due to noise coupled from the comparator inputs.

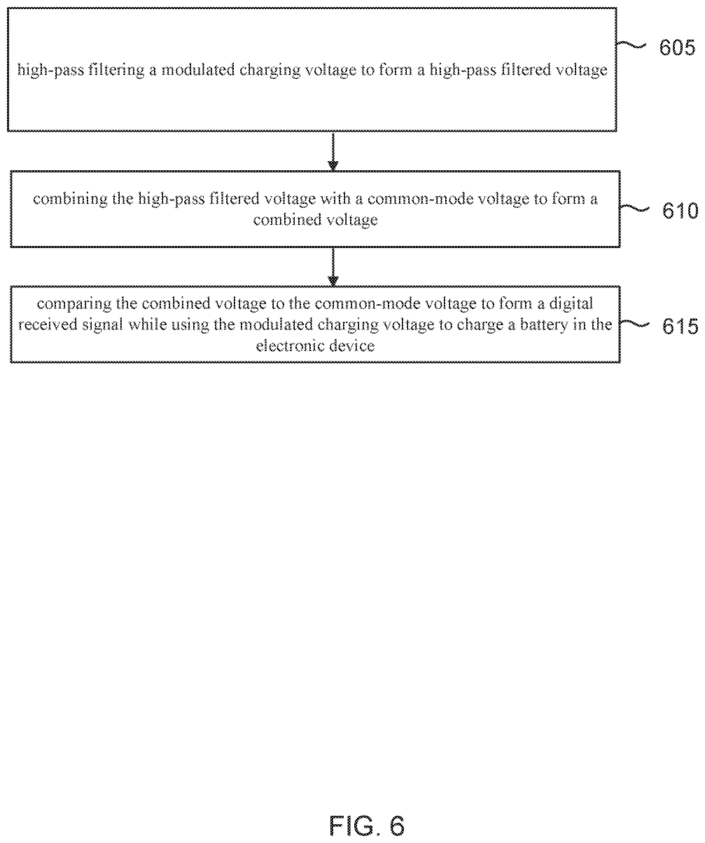

A method of receiving data from a charging voltage to an electronic device in accordance with the disclosure will now be discussed with respect to the flowchart of FIG. 6. The method includes an act 600 of modulating the charging voltage to form a modulated charging voltage that alternates between a high value that is greater than an average value of the charging voltage and a low value that is less than the average value of the charging voltage to form a modulated charging voltage. The modulating of the charging voltage VCHG is an example of act 600. The method also includes an act 605 of high-pass filtering the modulated charging voltage to form a high-pass filtered voltage. The high-pass filtering by high-pass filter 205 or by high-pass filter 515 is an example of act 610. The method further includes an act 615 of combining the high-pass filtered voltage with a common-mode voltage to form a combined voltage. The formation of the Vm node voltage in data receiver 500 or data receiver 200 is an example of act 615. Finally, the method includes an act 620 of comparing the combined voltage to the common-mode voltage to form a digital received signal while using the modulated charging voltage to charge a battery in the electronic device. The comparison by comparator 220 in data receiver 200 or 500 while battery 160 charges is an example of act 620.

The disclosure will now be summarized in the following series of clauses:
Clause 1. An electronic device, comprising:
   an input terminal for receiving a charging voltage;
   a first voltage divider configured to divide a power supply voltage into a divided voltage at a first node;
   a second voltage divider configured to divide the power supply voltage into the divided voltage at a second node;
   a high-pass filter including a high-pass filter capacitor coupled between the input terminal and the first node; and
   a comparator configured to compare a voltage of the first node to a voltage of the second node to form a digital received signal.
Clause 2. The electronic device of clause 1, wherein the electronic device comprises an earbud.
Clause 3. The electronic device of clause 2, wherein the earbud includes an integrated circuit, and wherein the comparator is integrated within the integrated circuit.
Clause 4. The electronic device of clause 3, wherein the earbud further comprises:
   an input switch coupled between a charging terminal of the integrated circuit and the input terminal.
Clause 5. The electronic device of clause 3, wherein the high-pass filter couples to the input terminal through a communication terminal of the integrated circuit.
Clause 6. The electronic device of any of clauses 1-5, further comprising:
   a low-pass filter coupled between the input terminal and the high-pass filter capacitor.
Clause 7. The electronic device of any of clauses 1-6, further comprising:
   a first capacitor coupled between the first node and ground.
Clause 8. The electronic device of any of clauses 1-7, further comprising:
   a second capacitor coupled between the second node and ground.
Clause 9. The electronic device of any of clauses 1-8, wherein the comparator is further configured to assert the digital received signal to a first binary value in response to the voltage of the first node exceeding a voltage of the second node by an offset value.
Clause 10. The electronic device of clause 9, wherein the comparator is further configured to assert the digital received signal to a second binary value in response to the voltage of the second node exceeding the voltage of the first node by the offset value.
Clause 11. The electronic device of clause 4, wherein the integrated circuit is configured to open the input switch during a high-speed data mode and to close the input switch during a low-speed data mode, wherein a data rate of the high-speed data mode is greater than a data rate of the low-speed data mode.
Clause 12. The electronic device of clause 2, further comprising a case configured to enclose the earbud, wherein the case includes an output terminal coupled to the input terminal while the earbud is enclosed.
Clause 13. The electronic device of clause 12, wherein the case is configured to charge the earbud with a charging voltage coupled through the output terminal.
Clause 14. The electronic device of clause 13, wherein the case is further configured to modulate the charging voltage with a digital message, and wherein the digital received signal includes the digital message.
Clause 15. A method of receiving data from a charging voltage to an electronic device, comprising:
   high-pass filtering a modulated charging voltage to form a high-pass filtered voltage;
   combining the high-pass filtered voltage with a common-mode voltage to form a combined voltage; and
   comparing the combined voltage to the common-mode voltage to form a digital received signal while using the modulated charging voltage to charge a battery in the electronic device.
Clause 16. The method of clause 15, wherein high-pass filtering the modulated charging voltage comprises:
   low-pass filtering the modulated charging voltage to form a low-pass-filtered modulated charging voltage; and
   high-pass filtering the low-pass-filtered modulated charging voltage to form the high-pass filtered voltage.
Clause 17. The method of any of clauses 15-16, further comprising:
   generating the common-mode voltage by dividing and low-pass filtering a power supply voltage of the electronic device.
Clause 18. The method of any of clauses 15-17, wherein the electronic device comprises an earbud, the method further comprising:
   recovering a digital message from the digital received signal while the earbud uses the modulated charging voltage to charge the battery.
Clause 19. The method of clause 18, further comprising:
   modulating a charging voltage to form the modulated charging voltage by alternatively increasing the modulated charging voltage to equal a sum of an average value of the charging voltage and a first voltage and decreasing the modulated charging voltage to equal the average value of the charging voltage minus a second voltage.
Clause 20. The method of clause 19, wherein the first voltage is substantially equal to the second voltage.
Clause 21. The method of clause 19, wherein the first voltage is approximately 100 mV.
Clause 22. An earbud, comprising:
   an input terminal;
   a charging rail for a charging voltage;
   an input switch coupled between the input terminal and the charging rail; and
   a data receiver coupled to the input terminal, wherein the data receiver includes a comparator and a high-pass filter coupled between the input terminal and a first input of the comparator.
Clause 23. The earbud of clause 22, wherein the data receiver further comprises:
   a first resistor coupled between a power supply node and the first input of the comparator; and
   a second resistor coupled between the first input of the comparator and ground.
Clause 24. The earbud of clause 23, wherein the data receiver further comprises:
   a third resistor coupled between the power supply node and a second input of the comparator; and
   a fourth resistor coupled between the second input of the comparator and ground.
Clause 25. The earbud of clause 23, wherein the high-pass filter comprises:
   the second resistor; and
   a high-pass filter capacitor coupled between the input terminal and the first input of the comparator.
Clause 26. The earbud of clause 25, further comprising:
   a low-pass filter coupled between the input terminal and the high-pass filter capacitor.
Clause 27. The earbud of clause 24, further comprising:
   a first capacitor coupled between the first input of the comparator and ground.
Clause 28. The earbud of clause 27, further comprising:
   a second capacitor coupled between the second input of the comparator and ground.
Clause 29. The earbud of clause 24, wherein the first input of the comparator is an inverting input of the comparator and the second input of the comparator is a non-inverting input of the comparator.

It will be appreciated that many modifications, substitutions and variations can be made in and to the materials, apparatus, configurations and methods of use of the devices of the present disclosure without departing from the scope thereof. In light of this, the scope of the present disclosure should not be limited to that of the particular implementations illustrated and described herein, as they are merely by way of some examples thereof, but rather, should be fully commensurate with that of the claims appended hereafter and their functional equivalents.

What is claimed is:

1. An electronic device, comprising:
an input terminal for receiving a charging voltage;
a first voltage divider configured to divide a power supply voltage into a divided voltage at a first node;
a second voltage divider configured to divide the power supply voltage into the divided voltage at a second node;
a high-pass filter including a high-pass filter capacitor coupled between the input terminal and the first node; and
a comparator configured to compare a voltage of the first node to a voltage of the second node to form a digital received signal.

2. The electronic device of claim 1, wherein the electronic device comprises an earbud.

3. The electronic device of claim 2, wherein the earbud includes an integrated circuit, and wherein the comparator is integrated within the integrated circuit.

4. The electronic device of claim 3, wherein the earbud further comprises:
an input switch coupled between a charging terminal of the integrated circuit and the input terminal.

5. The electronic device of claim 3, wherein the high-pass filter couples to the input terminal through a communication terminal of the integrated circuit.

6. The electronic device of claim 1, further comprising:
a low-pass filter coupled between the input terminal and the high-pass filter capacitor.

7. The electronic device of claim 1, further comprising:
a first capacitor coupled between the first node and ground.

8. The electronic device of claim 1, further comprising:
a second capacitor coupled between the second node and ground.

9. The electronic device of claim 1, wherein the comparator is further configured to assert the digital received signal to a first binary value in response to the voltage of the first node being greater than a voltage of the second node by an offset value.

10. The electronic device of claim 9, wherein the comparator is further configured to assert the digital received signal to a second binary value in response to the voltage of the second node being greater than the voltage of the first node by the offset value.

11. The electronic device of claim 4, wherein the integrated circuit is configured to open the input switch during a high-speed data mode and to close the input switch during a low-speed data mode, wherein a data rate of the high-speed data mode is greater than a data rate of the low-speed data mode.

12. The electronic device of claim 2, further comprising a case configured to enclose the earbud, wherein the case includes an output terminal coupled to the input terminal while the earbud is enclosed.

13. The electronic device of claim 12, wherein the case is configured to charge the earbud with a charging voltage coupled through the output terminal.

14. The electronic device of claim 13, wherein the case is further configured to modulate the charging voltage with a digital message, and wherein the digital received signal includes the digital message.

15. A method of receiving data from a charging voltage to an electronic device, comprising:
high-pass filtering a modulated charging voltage to form a high-pass filtered voltage;
combining the high-pass filtered voltage with a common-mode voltage to form a combined voltage; and
comparing the combined voltage to the common-mode voltage to form a digital received signal while using the modulated charging voltage to charge a battery in the electronic device.

16. The method of claim 15, wherein high-pass filtering the modulated charging voltage comprises:
low-pass filtering the modulated charging voltage to form a low-pass-filtered modulated charging voltage; and
high-pass filtering the low-pass-filtered modulated charging voltage to form the high-pass filtered voltage.

17. The method of claim 15, further comprising:
generating the common-mode voltage by dividing and low-pass filtering a power supply voltage of the electronic device.

18. The method of claim 15, wherein the electronic device comprises an earbud, the method further comprising:
recovering a digital message from the digital received signal while the earbud uses the modulated charging voltage to charge the battery.

19. The method of claim 18, further comprising:
modulating a charging voltage to form the modulated charging voltage by alternatively increasing the modulated charging voltage to equal a sum of an average value of the charging voltage and a first voltage and decreasing the modulated charging voltage to equal the average value of the charging voltage minus a second voltage.

20. The method of claim 19, wherein the first voltage is substantially equal to the second voltage.

21. The method of claim 19, wherein the first voltage is approximately 100 mV.

22. An earbud, comprising:
an input terminal;
a charging rail for a charging voltage;
an input switch coupled between the input terminal and the charging rail; and
a data receiver coupled to the input terminal, wherein the data receiver includes a comparator and a high-pass filter coupled between the input terminal and a first input of the comparator.

23. The earbud of claim 22, wherein the data receiver further comprises:
a first resistor coupled between a power supply node and the first input of the comparator; and
a second resistor coupled between the first input of the comparator and ground.

24. The earbud of claim 23, wherein the data receiver further comprises:
a third resistor coupled between the power supply node and a second input of the comparator; and
a fourth resistor coupled between the second input of the comparator and ground.

25. The earbud of claim 23, wherein the high-pass filter comprises:
the second resistor; and
a high-pass filter capacitor coupled between the input terminal and the first input of the comparator.

26. The earbud of claim 25, further comprising:
a low-pass filter coupled between the input terminal and the high-pass filter capacitor.

27. The earbud of claim 24, further comprising:
a first capacitor coupled between the first input of the comparator and ground.

28. The earbud of claim 27, further comprising:
a second capacitor coupled between the second input of the comparator and ground.

29. The earbud of claim 24, wherein the first input of the comparator is an inverting input of the comparator and the second input of the comparator is a non-inverting input of the comparator.
